(19) United States
(12) Patent Application Publication
(10) Pub. No.: US 2007/0089989 A1
(43) Pub. Date: Apr. 26, 2007

(54) CONFORMABLE HYDROGEN INDICATING WRAP TO DETECT LEAKING HYDROGEN GAS

(76) Inventors: William Hoagland, Boulder, CO (US); David K. Benson, Golden, CO (US); Rodney K. Smith, Golden, CO (US)

Correspondence Address: COCHRAN FREUND & YOUNG LLC, 2026 CARIBOU DR, SUITE 201, FORT COLLINS, CO, 80525, US

(21) Appl. No.: 11/470,218

(22) Filed: Sep. 5, 2006

Related U.S. Application Data
(60) Provisional application No. 60/713,806, filed on Sep. 2, 2005.

(51) Int. Cl. G01N 27/26

(52) U.S. Cl. 204/424

(57) ABSTRACT

A hydrogen gas leak detector comprises a thin film hydrogen detector on a sheet of conformable substrate material, for example, a plastic cling wrap material or a plastic heat shrink material, that is wrappable around a component from which hydrogen gas might leak or evolve. The thin film hydrogen detector may comprise a thin film hydrogen detecting material, for example, a metal oxide, and a thin film catalyst material. The conformable substrate material can be transparent or translucent.

### CROSS-REFERENCE TO RELATED APPLICATION

This application claims benefit of and priority to U.S. Provisional Patent Application serial No. 60/713,806 entitled “Conformable Hydrogen Indicating Wrap to Detect Leaking Hydrogen Gas” by William Hoagland, David K. Benson and Rodney D. Smith, filed Sep. 2, 2005, the entire contents of which are specifically incorporated herein by reference for all that it discloses and teaches.

### BACKGROUND OF THE INVENTION

### FIELD OF THE INVENTION

In the coming decades, hydrogen may be stored and used in vast quantities for new energy systems. Advances in fuel cells and advances to electric vehicles have brought hydrogen gas to the forefront of the various energy candidates to meet our future energy demands. However, there remains a general perception about the safety of hydrogen, especially with respect to the widespread use of hydrogen gas as a fuel.

Concerns about hydrogen safety could be a longstanding and formidable barrier to its early introduction as a fuel in clean, sustainable energy systems. Prominent among these concerns may be the possibility of a fire or explosion resulting from an undetected hydrogen gas leak. Current technology for detecting the presence of free hydrogen in a mixture of other gases has improved, and there exist various regulations requiring the use of hydrogen detection devices to detect the presence of hydrogen gas at one volume percent where gaseous hydrogen buildup is possible (29 C.F.R. 1910.106 (1996)) and at 0.4 volume percent for confined spaces (29 C.F.R. 191.146 (1996)).

### SUMMARY OF THE INVENTION

An embodiment of the invention may therefore comprise a hydrogen indicator comprising: a conformable, transparent, shrink-wrap, polymer substrate film; an atomic hydrogen sensor material supported by the substrate that changes properties in the presence of hydrogen; and a catalyst material deposited on the atomic hydrogen gas sensor material that converts molecular hydrogen gas to atomic hydrogen gas sensed by the atomic hydrogen sensor material.

An embodiment of the present invention may further comprise a hydrogen indicator comprising: a conformable, transparent, self-adhering, polymer substrate film; an atomic hydrogen sensor material supported by the substrate that changes properties in the presence of hydrogen; a catalyst material deposited on the atomic hydrogen gas sensor material that converts molecular hydrogen gas to atomic hydrogen gas sensed by the atomic hydrogen sensor material.

An embodiment of the present invention may further comprise a hydrogen indicator comprising: a conformable, transparent, shrink-wrap, polymer substrate film that surrounds and encapsulates an object upon application of heat; an atomic hydrogen sensor material supported by the substrate that reversibly switches from a first conduction state to a second conduction state in response to atomic hydrogen gas; a catalyst material that facilitates conversion of molecular hydrogen gas to atomic hydrogen that is sensed by the atomic hydrogen sensor material; a circuit operably responsive to the atomic hydrogen gas sensor material that generates a signal that is indicative of the presence of hydrogen.

An embodiment of the present invention may further comprise a hydrogen indicator comprising: a conformable, transparent, self-adhering, polymer substrate film that surrounds and encapsulates an object by adhering to the object and to itself; an atomic hydrogen sensor material supported by the substrate that reversibly switches from a first conduction state to a second conduction state in response to atomic hydrogen gas; a catalyst material that facilitates conversion of molecular hydrogen gas to atomic hydrogen that is sensed by the atomic hydrogen sensor material; a circuit operably responsive to the atomic hydrogen gas sensor material that generates a signal that is indicative of the presence of hydrogen.

An embodiment of the present invention may further comprise a method of making a hydrogen detector comprising: providing a conformable, transparent, shrink-wrap, polymer substrate film that shrinks upon application of heat; depositing an atomic hydrogen sensor material on the substrate film that changes properties in the presence of hydrogen; depositing a catalyst material on the atomic hydrogen sensor material that facilitates conversion of molecular hydrogen gas to atomic hydrogen.

An embodiment of the present invention may further comprise a method of making a hydrogen detector comprising: providing a conformable, transparent, self-adhering, polymer substrate film that shrinks upon application of heat; depositing an atomic hydrogen sensor material on the substrate film that changes properties in the presence of hydrogen; depositing a catalyst material on the atomic hydrogen sensor material that facilitates conversion of molecular hydrogen gas to atomic hydrogen; depositing a gas diffusion barrier layer on the catalyst material, the gas diffusion barrier layer being selectively permeable to molecular hydrogen gas.

### BRIEF DESCRIPTION OF THE DRAWINGS

FIG. 1 is a side view of one embodiment of a hydrogen sensor.

FIG. 2 is a cutaway perspective view of another embodiment of a hydrogen sensor.

FIG. 3 is a perspective cutaway view of another embodiment of a hydrogen sensor.

FIG. 4 is a schematic illustration of the application of one embodiment.

FIG. 5 is a schematic illustration of the application of another embodiment.

FIG. 6 is a perspective view of another embodiment of a hydrogen sensor.

FIG. 7 is a perspective view of the embodiment of FIG. 6.

FIG. 8 is a perspective view of another embodiment of a hydrogen sensor.

FIG. 9 is a top view of another embodiment of a hydrogen sensor.

FIG. 10 is a top view of another embodiment of a hydrogen sensor.

### DETAILED DESCRIPTION OF THE EMBODIMENTS

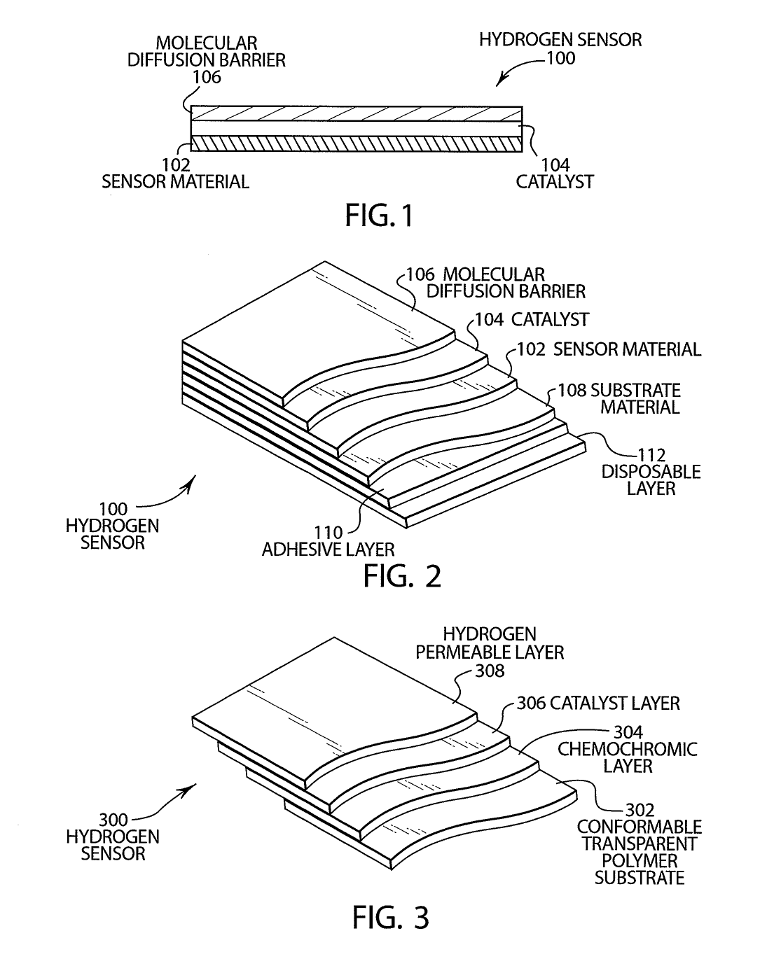

FIG. 1 is a side view of a hydrogen sensor 100 comprising three components, a sensor material 102, a catalyst 104 and an optional molecular diffusion barrier 106, all of which are described in more detail herein. The first component is a hydrogen sensor material 102 that may comprise transition metal oxides, or oxysalts such as vanadium oxide, tungsten oxide, molybdenum oxide, yttrium oxide, or combinations thereof, as examples. When exposed to atomic hydrogen, the metal oxide can be reduced to a lower oxidation state of the metal. Persons skilled in the art understand that a lower oxidation state means an oxidation state with fewer oxygen atoms in the compound than a higher oxidation state. For example, tungsten oxide (WO₂) is a lower oxidation state of tungsten oxide (WO₃). The reduction of the metal oxide to a lower oxidation state of the metal can be accompanied or manifested by a change in electrical conduction, electrical resistivity, electrocapacitance, magneto-resistance, photoconductivity, or optical properties of the hydrogen sensor 102 or in a combination of one or more of such changes. The change in such physical property or properties can be reversed by removing the transition metal oxide(s) from exposure to hydrogen and by exposing the sensor material 102 to oxygen, or the partial pressure of oxygen available in a mixture of gases, thereby converting the transitional metal oxide back to its original metal oxide state. In some embodiments, the hydrogen sensor material 102 may comprise chemochromic transition metal oxide such as, for example, but not for limitation, tungsten oxide, which becomes noticeably darker in color upon conversion from a higher oxidation state of tungsten oxide to a lower oxidation state of tungsten oxide. The color change is reversible upon exposing the lower oxidation state of tungsten oxide to oxygen to convert it back to a higher oxidation state. There are many other chemochromic materials besides tungsten oxide that are well-known in the art and that can be used for th echemochromic hydrogen sensor material 102. In other embodiments of the invention, the hydrogen gas sensor can be part of a circuit that can carry a signal. The output of the signal can be indicative of the presence or absence of hydrogen in the environment. In certain embodiments of the invention, by way of example, and not limitation, the hydrogen sensor material 102 can comprise a thin film having a thickness of between about 0.2 microns to about 10 microns in thickness. The transition metal oxide thin film can be formed by vacuum vapor deposition, sputtering, electrophoretic, or other methods of metal deposition. The hydrogen sensor material 102 may be of a form as more fully described in the following references: U.S. Pat. No. 5,356,756 issued Oct. 18, 1994 to R. Cavicchi et al.; U.S. Pat. No. 5,345,213 issued Sep. 6, 1994 in the names of S. Semancik, et al., each of which is specifically incorporated herein by reference for all that they disclose and teach. In addition, the following articles also describe hydrogen sensor materials: J. S. Suehle, R. E. Cavicchi, M. Gaitan, and S. Semancik, “Tin Oxide Gas Sensor fabricated using CMOS Micro-hotplates and In Situ Processing,” IEEE Electron Device Lett. 14, 118-120 (1993); S. Semancik and R. E. Cavicchi, “The use of surface and thin film science in the development of advanced gas sensors,” Appl. Surf. Sci 70/71, 337-346 (1993); R. E. Cavicchi, J. S. Suehle, K. G. Kreider, M. Gaitan, and P. Chaparala, “Fast Temperature Programmed Sensing for Microhotplate Gas Sensors,” IEEE Electron Device Letters 16, 286-288 (1995); R. E. Cavicchi, J. S. Suehle, K. G. Kreider, B. L. Shomaker, J. A. Small, M. Gaitan, and P. Chaparala, “Growth of SnO.sub.2 films on micromachined hotplates,” Appl. Phys. Lett. 66 (7), 812-814 (1995); C. L. Johnson, J. W. Schwank, and K. D. Wise, “Integrated Ultra-thin film gas sensors,” Sensors and Act B 20, 55-62 (1994); X. Wang, W. P. Carey, and S. S. Yee, “Monolithic thin film metal oxide gas sensor arrays with application to monitoring of organic vapors,” Sensors and Actuators B 28, 63-70 (1995); N. R. Swart and A. Nathan, “Design Optimization of integrated microhotplates,” Sensors and Act A 43, 3-10 (1994); and N. Najafi, K. D. Wise, and J. W. Schwank, “A micromachined thin film gas sensor,” IEEE Electron Device Lett. 41 (10) (1994); F. DiMeo Jr., S. Semancik, R. E. Cavicchi et al., “MOCVD of SnO.sub.2 on silicon microhotplate arrays for use in gas sensing application,” Mater. Res. Soc. Symp. Proc. 415, 231-6 (1996).

Referring again to FIG. 1, the second component of the hydrogen sensor 100 comprises a catalyst material 104 that facilitates the conversion of molecular hydrogen to atomic hydrogen. With respect to some embodiments of the invention the catalyst material 104 can be selected from the group comprising platinum, palladium, rhodium, nickel, combinations of these metals, or alloys of these materials with other metals such as copper, cobalt, iridium, magnesium, calcium, barium, strontium, or the like. The catalyst material 104 can be applied directly to the hydrogen gas sensor, as described above, and can have thickness, for example, but not by way of limitation, of between about 0.001 micron to about 10 microns.

A third component of the hydrogen sensor 100 can comprise a molecular diffusion barrier 106 that allows selectively permeable diffusion of molecular hydrogen or atomic hydrogen to the exclusion of oxygen and other contaminants. The molecular diffusion barrier 106 is preferably a continuous barrier and has an atomic density that provides an effective barrier against unwanted oxidation of the transition metal oxide of the hydrogen sensor material 102. The thickness of the molecular diffusion barrier layer 106 can be readily selected to minimize oxygen permeation, while maximizing the response of the hydrogen sensor material 102 to atomic hydrogen. The protective molecular diffusion barrier 106 can comprise at least one thin metal film such as palladium, platinum, iridium, or other noble metals, or precursors of such metals that may be used for deposition, or can comprise a polymer such as: polyamides, polyacrylamides, polyacrylate, polyalkylacrylates, polystyrenes, polynitriles, polyvinyls, polyvinylchlorides, polyvinyl alchohols, polydienes, polyesters, polycarbonates, polysiloxanes, polyurethanes, polyolefins, polyimides, or heteropolymeric combinations thereof. See U.S. Patent Publication No. 20010012539, which discloses diffusion barrier layers and is specifically incorporated herein by reference for all that it discloses and teaches. The molecular diffusion barrier 106 can be coupled to the catalyst material, or in those embodiments of the invention that do not employ a catalyst layer 104, can be coupled to the hydrogen sensor material 102.

Referring to FIG. 2, a substrate material 108 is disclosed that supports the hydrogen sensor 100. The substrate material 108, with respect to some embodiments of the invention, can be selected from the group of glass, metal, mineral, plastic, paper, or conformable plastic films such as shrink-wrap films (polyolefin) and self-adhering films, such as are used for wrapping foods or the like. The substrate material 108 can be configured as blanks cut from substantially rigid sheet material, or the substrate material 108 can be a flexibly conformable material that can conformably mate with other objects that carry, interact with, or are employed in the distribution of hydrogen gas, such as pipes, containers, pumps, or the like as described in more detail below. Further, the substrate material 108 can be a rigidly configured material that makes up a component or element that is assembled as part of a construct to carry, interact with, or is employed in the distribution of hydrogen gas. Further, the substrate material 108 can be a material installed or used within an enclosed area in which hydrogen gas can collect. The substrate material 108 can also be a material used to make clothing, outerwear, or accessories worn by individuals that work or utilize spaces, areas, or enclosures that can potentially bring them into contact with hydrogen gas. Further, the substrate material 108 can be configured to fit into a container, holder, sampler, badge, or other construct in manner that the hydrogen gas indicator can interact with the gaseous environment.

An adhesive layer 100 can also be provided on at least a portion of the surface of the substrate material 108, such that the substrate material can be adhesively attached to structures similar to adhesive tape. The invention may also further comprise a disposable layer 112 to which the substrate material 108 having an adhesive layer 110 on at least a portion of the surface can be separably or peelably joined, such as decals, adhesive strips, adhesive dots, or the like.

The substrate material 108 can be a friable substrate that can be crumbled or broken into particles. The friable substrate 108 can be made to support the hydrogen sensor material 102 prior to being crumbled or broken into particles such that only a portion of the surface of the particle of the friable substrate material 108 supports a hydrogen sensor material 102. Alternatively, the particles of the friable substrate material 108 can be made to support the sensor material 102 after the friable substrate material 108 is crumbled, broken, or reduced in size to particles such that all the surfaces of the resulting particles support the sensor material 102. Naturally, the particles may also be made from other types of materials or result from different processes (such as machining, molding, or the like) and can comprise numerous particle sizes, types, or kinds in homogeneous populations or mixtures thereof. The particles that support the sensor material 108 may be sized to be used as pigments within liquid substances, such as paint, polymers, elastomers, gels, or the like.

FIG. 3 is a schematic illustration of an embodiment of a hydrogen sensor 300. Hydrogen sensor 300 has a conformable transparent polymer substrate 302. The conformable transparent polymer substrate 302 can comprise a plastic film, such as commercially available plastic wrap for wrapping foods, or a shrink-wrap type of material. Commercial available plastic wraps have the advantage of clinging to objects when wrapped on those objects, as well as clinging to themselves when wrapped around objects. These types of plastic wraps are conformable to the object and provide the additional benefit of securing the hydrogen sensor 300 to the object in a simple and easy fashion by either clinging to the object, or clinging to itself, when wrapped around the object. In the case of a shrink-wrap type material, the polymer shrink-wrap that comprises the conformable transparent polymer substrate 302 can be wrapped around the object and have heat applied to the wrap to shrink the wrap and thereby fully encapsulate the object. In this manner, the capture of the hydrogen emanating or evolving from the object with the hydrogen sensor 300 can be ensured, and the hydrogen sensor 300 can provide an indication of any such hydrogen.

A chemochromic hydrogen sensor material 304 is placed on the conformable transparent polymer substrate 302 in any of the ways that the sensor material 102 is placed on the substrate material 108, as described with respect to FIG. 2. The catalyst layer 306 is applied to the chemochromic hydrogen sensor material 304 in the same manner that the catalyst 104 is applied to the sensor material 102 of FIG. 2. Further, the hydrogen permeable, barrier layer 308 is applied to the catalyst layer 306 in the same manner that the molecular diffusion barrier 106 is applied to the catalyst layer 104. The chemochromic hydrogen sensor material 304 can comprise any of the hydrogen sensor materials, such as the sensor materials 102 described above. The catalyst layer 306 can comprise any of the catalysts, such as catalyst 104 described with respect to FIG. 2. The catalyst layer 306, for example, can be a noble metal catalyst layer such as platinum or palladium, or other noble metals. The hydrogen permeable layer 308 can comprise any of the molecular diffusion barriers 106 that are described with respect to FIG. 2. The hydrogen permeable layer 308 provides a protective coating for mechanical and chemical protection of the chemochromic sensor material 304 and the catalyst layer 306. The hydrogen permeable layer 308 is a protective coating that is semi-permeable. The protective coating of the hydrogen permeable layer 308 allows hydrogen to pass through the permeable layer 308 that excludes elements or compounds that would deactivate or otherwise damage the chemochromic sensor material 304. The hydrogen permeable layer 308 may comprise various forms of Teflon as well as other types of materials.

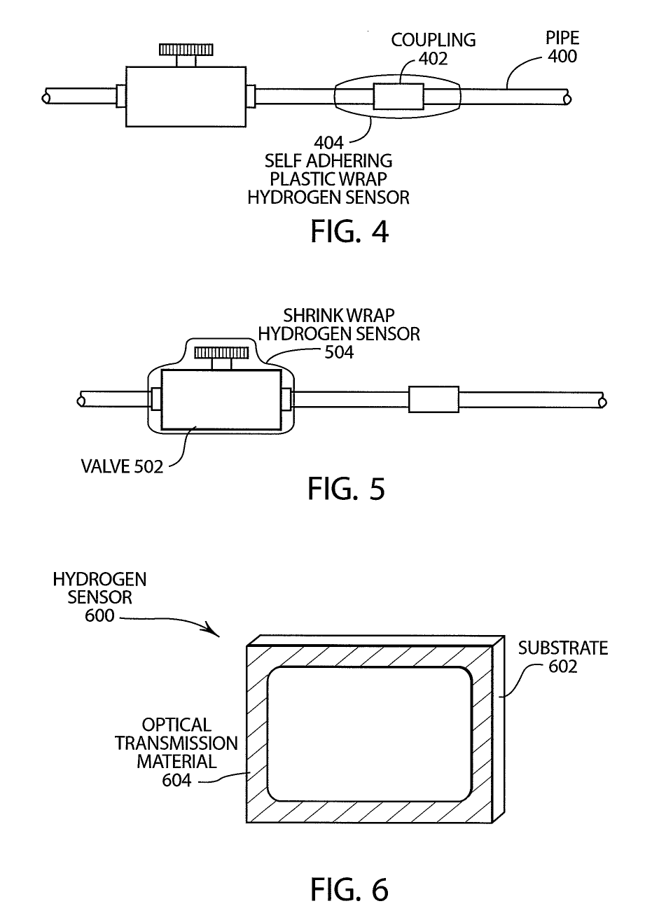

FIG. 4 is a diagrammatic illustration of the use of a self-adhering plastic wrap or cling wrap hydrogen sensor 404 being used to sense hydrogen leaks from a coupling 402 in a pipe 400. As shown in FIG. 4, the self-adhering plastic wrap hydrogen sensor 404 is wrapped around the coupling 402 and adheres to the coupling 402 and pipe 400 as well as to itself. The plastic wrap 404 is wrapped so that the conformable transparent polymer substrate 302 (FIG. 3) is on the outside and the hydrogen permeable layer 308 is on the inside of the wrap adjacent the coupling 402 and pipe 400. If hydrogen leaks from the coupling 402, the hydrogen sensor 404 will change colors or darken, which indicates a hydrogen leak. The transparent polymer sheets that comprise the conformable transparent polymer substrate 302 of the self-adhering plastic wrap hydrogen sensor 404 allow the change in color or transparency to be viewed by an observer. Of course, automated means can be employed to detect a change in color or transparency, such as the use of electro optic sensors. The self-clinging properties of the conformable transparent polymer substrate 302 allow the hydrogen sensor 300 to be easily disposed on various objects and easily conformed to the shape of those objects. The hydrogen sensor 300 overlaps itself and is held in position by the self-clinging properties of the conformable transparent polymer substrate 302.

FIG. 5 is a schematic illustration of the use of a shrink-wrap hydrogen sensor 504 that encapsulates a valve 502. In this embodiment, the conformable transparent polymer substrate 302 (FIG. 3) comprises a heat-shrink plastic film that is typically, but not necessarily, made from a polyolefin polymer that is used for security packaging of retail items. In this case, the hydrogen sensor 504 includes each of the layers illustrated in FIG. 3. The conformable transparent polymer substrate 302 in the shrink-wrap hydrogen sensor 504 is a shrink-wrap material. The shrink-wrap hydrogen sensor 504 is wrapped around the valve 502 or other object, which is to be monitored for hydrogen. Shrink-wrap hydrogen sensor 504 is then heated moderately to cause it to shrink and conform to the shape of the valve 502. In this manner, the valve 502 is encapsulated by the shrink-wrap hydrogen sensor 504 to ensure a reliable detection of hydrogen that may leak from the valve 502. Of course, any object can be encapsulated in this manner. As disclosed below, the self-adhering plastic wrap hydrogen sensor 404, as well as the shrink-wrap hydrogen sensor 504, can be encoded with indicia to indicate the existence of hydrogen.

Referring to FIGS. 6, 7, 8, and 9, a hydrogen sensor is illustrated that has discrete indicia 700 that are responsive to hydrogen. The indicia 700 comprise the hydrogen sensor material 702 and provide indication of detection of hydrogen gas. Alternatively, the discrete indicia 700 are operatively connected to the hydrogen sensor material 802 and provide an indication of the detection of hydrogen in a manner that is discrete from the change in physical, chemical, or electrical properties of the hydrogen sensor material 802 itself. With respect to some embodiments of the invention, discrete indicia 700 can include alpha-numeric characters or symbols arranged in any number, variety or combination of languages or notations. The alpha-numeric indicia or symbols, while operatively responsive to the hydrogen sensor material 802, provide additional indicia discrete from any information that can be obtained directly from the hydrogen sensor material 802 itself. The alpha-numeric indicia 700 can, as examples, provide a warning, or could provide instructions, or could provide a map, or display, present, or provide any other information, instruction, or guidance, in response to the presence of hydrogen gas.

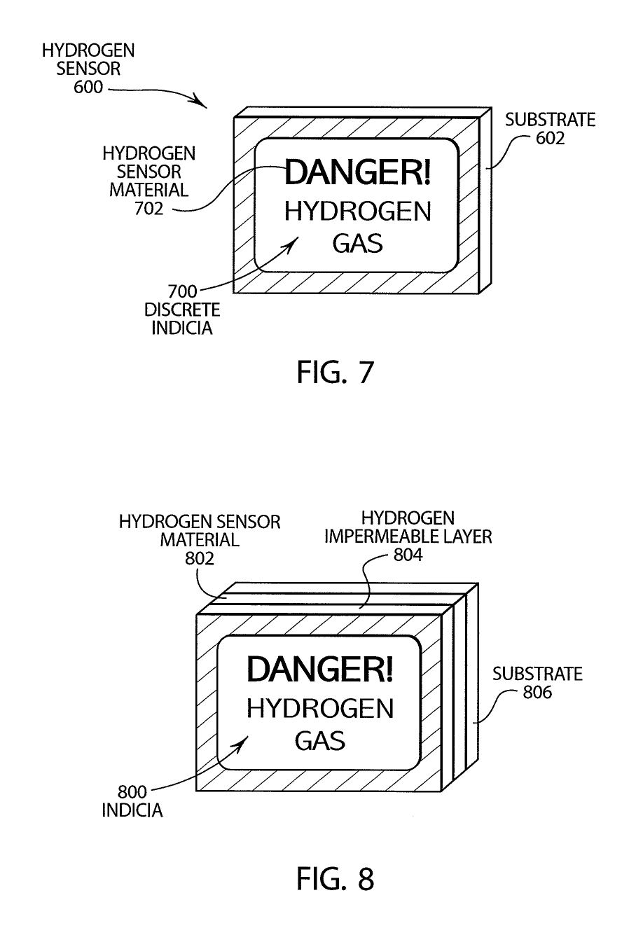

The following illustrative examples of discrete indicia 700 are not meant to limit the numerous and varied embodiments of discrete indicia that can be made operably responsive to the hydrogen sensor material 802. As shown by FIGS. 6 and 7, certain embodiments can comprise a substrate material 602 having an optical transmission material 604 coupled to portions of the surface of the substrate material 602. The optical transmission material 604 can comprise ink, paint, dye, or other pigmented material, but can also comprise a texture added to the surface of the substrate material 602 during molding or configuration of the substrate material 602, or can be the result of other treatment of the surface of the substrate material 602, such as particle blasting, surface abrasion, electroplating, chemical vapor deposition, or the like. Discrete indicia 700 that indicate the presence of hydrogen gas are then added, such as the words “Danger! Hydrogen Gas” that are operably responsive to the hydrogen sensor material 302, so that this discrete indicia 700 are provided only in response to the presence of hydrogen gas.

In certain embodiments of the invention, a portion of the surface of the substrate material 602 can be masked or protected leaving unmasked or unprotected surface configured as discrete indicia 700. The substrate can then be processed by the various methods described above to couple hydrogen sensor material 702 to the unmasked portion of the substrate material 602 generating discrete indicia 700 that are observable when the hydrogen sensor material 802 is exposed to hydrogen gas.

In other embodiments of the invention the discrete indicia 700 can be applied as a dye, ink, paint, gel, polymer, or other substance that can entrain pigment particles of the sensor material 702. Such particles can include the catalyst material 104 or the molecular diffusion barrier layer 106, or both, as homogeneous populations of particles or in various combinations or permutations. The color or opacity of the substance entraining the particles of the hydrogen sensor material 702 that are applied as discrete indicia 700 can change from a first color or opacity, to a second color or opacity, in the presence of hydrogen gas.

Referring to FIG. 8, conventional optical transmission material 604 (FIG. 6) does not have to be incorporated into all embodiments. In certain embodiments, a portion of the surface of the substrate material 806, as desired, can be coupled to the hydrogen sensor material 102, and a further hydrogen impermeable material 804 can be coupled to selected portions of the hydrogen sensor material 102, which can in some embodiments of the invention also include the catalyst material 104 or the molecular diffusion barrier 106, that is selectively permeable to hydrogen gas, or both, leaving discrete indicia 800 configured in the hydrogen impermeable layer 804. When the substrate material 806 is then exposed to hydrogen gas, that portion of the hydrogen sensor material 802 that is not covered by impermeable material 804, which is configured with discrete indicia 800, reacts with the hydrogen gas providing viewable discrete indicia 800. Upon removal from hydrogen gas, the hydrogen sensor material 802 can return to the oxidized color of the transition metal to match the color of the hydrogen sensor material that is covered by the hydrogen impermeable layer 804. The discrete indicia 800 become substantially undiscernible.

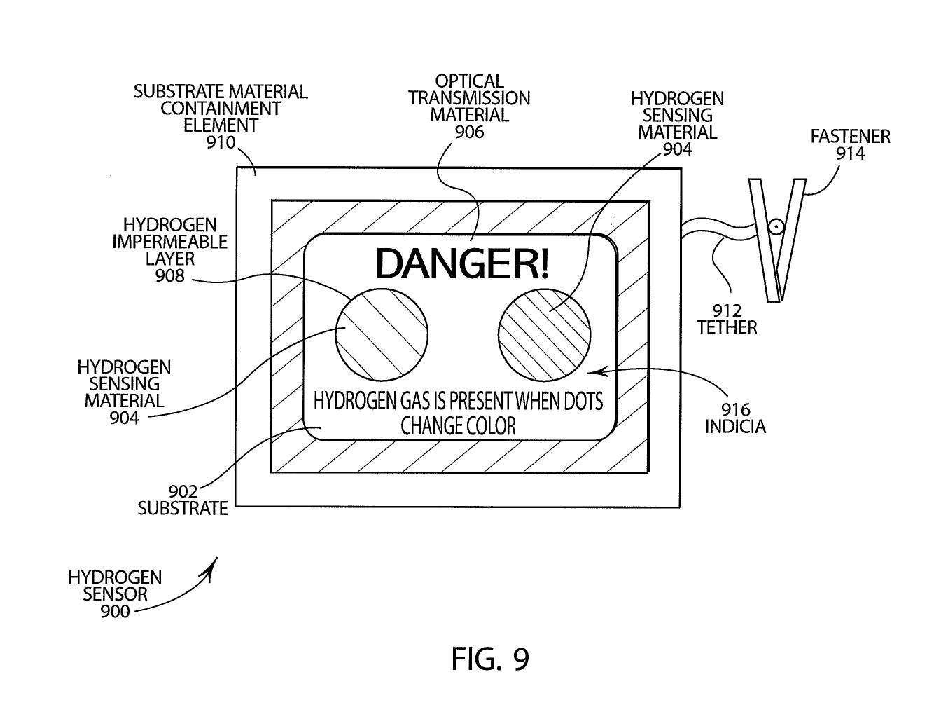

FIG. 9 illustrates another embodiment of a hydrogen sensor 900 that includes a substrate material 902, a hydrogen sensor material 904, a catalyst material 104, a molecular diffusion barrier 106, a hydrogen impermeable material 908 and conventional optical transmission materials 906. The invention can further comprise a substrate material containment element 910. As shown in FIG. 5, the substrate material containment element 910 can be configured to hold the substrate material 902 in a badge or accessory to be worn on clothing. In certain embodiments, a tether 912 can be joined to the containment element 910 terminating in a fastener 914, which can include pins, clips, clasps, adhesive, or the like. The tether 912 can be attached directly to the substrate material 902. The substrate material can also be a substrate material 902 conformable to outerwear, such as a plastic sheet or paper sheet, having an adhesive layer 110 (FIG. 2) coupled to at least a portion of the conformable substrate material 902. As to these embodiments, a person can simply press the adhesive layer to outerwear and peel the substrate material 902 from the outerwear for disposal, if desired. As described above, the adhesive layer 110 can be separably or peelably joined to a disposable layer 112 for convenience of storage, or the convenience of manufacture wherein a large quantity of a particular substrate material 902 with particular discrete indicia 916 are to be made.

The containment element 910 can also comprise a container to which hydrogen gas sensor particles are transferred. Hydrogen gas sensor particles can have a mixture of gases passed over or through them as a manner of sampling the gaseous environment. The containment element holding the hydrogen sensor particles can be at a location remote from the gaseous mixture being sampled. The gaseous mixture being sampled is transferred to the hydrogen gas indicator by way of a closed conduit communicating between the gaseous mixture and the containment element 910.

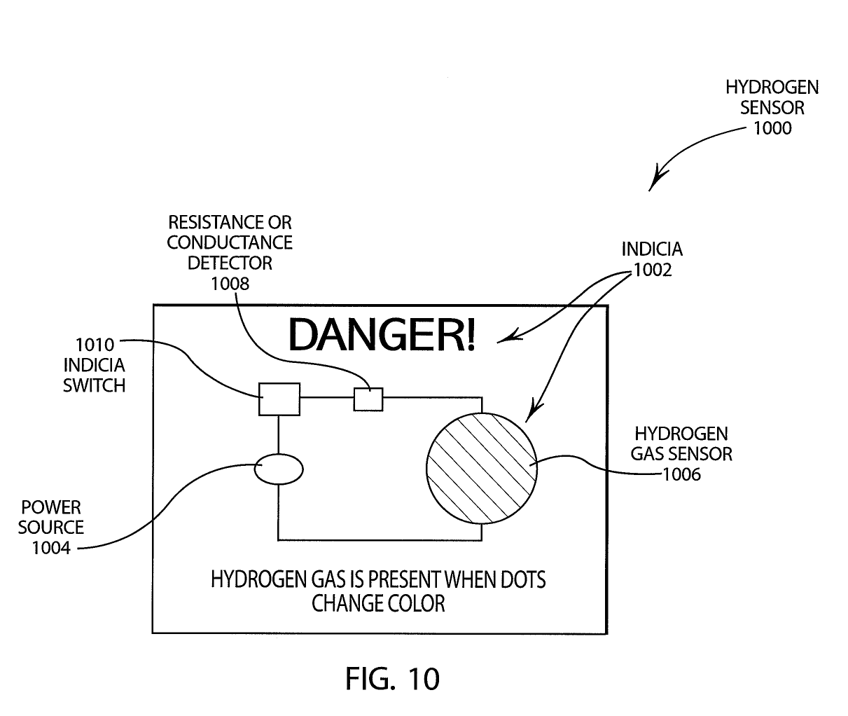

Now referring primarily to FIG. 10, embodiments of a hydrogen sensor 1000 can further include circuitry that utilizes the reversible electrical properties of the hydrogen sensor material 102, including the catalyst material 104, or the molecular diffusion barrier 106, or both, as desired, as a manner of switching certain discrete indicia 1002 on or off. A power source 1004, which could be a battery, photovoltaic cell, or other type of power source, provides current, while the hydrogen gas sensor 1006 provides a variable resistance or conductance in response to exposure to hydrogen gas. A resistance or conductance differentiation detector 1008 can be further added to the circuitry as required or desired. When the hydrogen gas sensor 1006 is exposed to hydrogen gas, the resistance or conductance of the hydrogen gas sensor 1006 changes. This change is used to switch the indicia switch 1010 to turn the switchably operable discrete indicia on or off. Switchably operable discrete indicia can include a signal generator that provides a visual or audible or tactile signal. The audible signal generator can generate a digitized message, or a tone. The tactile signal generator can generate a vibration or modulated frequency that can be felt by a person in proximity to the hydrogen sensor 1000. The visual generator can turn on an illumination source.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A hydrogen indicator comprising:
a conformable, transparent, shrink-wrap, polymer substrate film;
an atomic hydrogen sensor material supported by said substrate that changes properties in the presence of hydrogen; and
a catalyst material deposited on said atomic hydrogen sensor material that converts molecular hydrogen gas to atomic hydrogen gas sensed by said atomic hydrogen gas sensor material.

2. The hydrogen indicator of claim 1, wherein said catalyst material is selected from the group consisting of platinum, palladium, rhodium, nickel, and alloys of these materials with other metals.

3. The hydrogen indicator of claim 1, wherein said atomic hydrogen sensor material is selected from the group consisting of vanadium oxide, tungsten oxide, molybdenum oxide, yttriun oxide, and combinations thereof.

4. The hydrogen indicator of claim 2, wherein said atomic hydrogen sensor material is selected from the group consisting of vanadium oxide, tungsten oxide, molybdenum oxide, yttriun oxide, and combinations thereof.

5. A hydrogen gas indicator as described in claim 4 further comprising discrete indicia operatively coupled and responsive to said atomic hydrogen sensor material.

6. The hydrogen indicator of claim 1, including a diffusion barrier coupled to said catalyst material.

7. The hydrogen indicator of claim 1, wherein the diffusion barrier is selectively permeable to molecular hydrogen gas.

8. A hydrogen indicator comprising:
a conformable, transparent, self-adhering, polymer substrate film;
an atomic hydrogen sensor material supported by said substrate that changes properties in the presence of hydrogen; and
a catalyst material deposited on said atomic hydrogen gas sensor material that converts molecular hydrogen gas to atomic hydrogen gas sensed by said atomic hydrogen sensor material.

9. The hydrogen indicator of claim 8, wherein said catalyst material is selected from the group consisting of platinum, palladium, rhodium, nickel, and alloys of these materials with other metals.

10. The hydrogen indicator of claim 8, wherein said atomic hydrogen sensor material is selected from the group consisting of vanadium oxide, tungsten oxide, molybdenum oxide, yttriun oxide, and combinations thereof.

11. The hydrogen indicator of claim 9, wherein said atomic hydrogen sensor material is selected from the group consisting of vanadium oxide, tungsten oxide, molybdenum oxide, yttriun oxide, and combinations thereof.

12. A hydrogen gas indicator as described in claim 11, further comprising discrete indicia operatively coupled and responsive to said atomic hydrogen sensor material.

13. The hydrogen indicator of claim 8, including a diffusion barrier coupled to said catalyst material, said diffusion barrier being selectively permeable to molecular hydrogen gas.

14. A hydrogen indicator comprising:
a conformable, transparent, shrink-wrap, polymer substrate film that surrounds and encapsulates an object upon application of heat;
an atomic hydrogen sensor material supported by said substrate that reversibly switches from a first conduction state to a second conduction state in response to atomic hydrogen gas;
a catalyst material that facilitates conversion of molecular hydrogen gas to atomic hydrogen that is sensed by said atomic hydrogen sensor material; and
a circuit operably responsive to said atomic hydrogen gas sensor material that generates a signal that is indicative of the presence of hydrogen.

15. The hydrogen indicator of claim 14, including a gas diffusion barrier deposited on said catalyst material, said gas diffusion barrier being selectively permeable to molecular hydrogen gas.

16. A hydrogen indicator comprising:
a conformable, transparent, self-adhering, polymer substrate film that surrounds and encapsulates an object by adhering to said object and to itself;
an atomic hydrogen sensor material supported by said substrate that reversibly switches from a first conduction state to a second conduction state in response to atomic hydrogen gas;
a catalyst material that facilitates conversion of molecular hydrogen gas to atomic hydrogen that is sensed by said atomic hydrogen sensor material; and
a circuit operably responsive to said atomic hydrogen gas sensor material that generates a signal that is indicative of the presence of hydrogen.

17. The hydrogen indicator of claim 16, including a gas diffusion barrier deposited on said catalyst material, said gas diffusion barrier being selectively permeable to molecular hydrogen gas.

18. A method of making a hydrogen detector comprising:
providing a conformable, transparent, shrink-wrap, polymer substrate film that shrinks upon application of heat;
depositing an atomic hydrogen sensor material on said substrate film that changes properties in the presence of hydrogen; and
depositing a catalyst material on said atomic hydrogen sensor material that facilitates conversion of molecular hydrogen gas to atomic hydrogen.

19. The method of claim 18, including depositing a gas diffusion barrier layer on said catalyst material, said gas diffusion barrier layer being selectively permeable to molecular hydrogen gas.

20. A method of making a hydrogen detector comprising:
providing a conformable, transparent, self-adhering, polymer substrate film that shrinks upon application of heat;
depositing an atomic hydrogen sensor material on said substrate film that changes properties in the presence of hydrogen; and
depositing a catalyst material on said atomic hydrogen sensor material that facilitates conversion of molecular hydrogen gas to atomic hydrogen.

21. The method of claim 20, including depositing a gas diffusion barrier layer on said catalyst material, said gas diffusion barrier layer being selectively permeable to molecular hydrogen gas.

22. A method of detecting hydrogen gas leaking from a component, comprising:
fabricating a hydrogen detector film that changes color or transparency when exposed to hydrogen gas on a conformable substrate film; and
wrapping the conformable substrate film around the component.

23. The method of claim 22, wherein the conformable substrate material is transparent.

24. The method of claim 23, wherein the hydrogen detector film includes a hydrogen sensor material that changes color and/or transparency upon exposure to hydrogen.

25. The method of claim 24, wherein the hydrogen detector film includes a catalyst material adjacent the hydrogen sensor material.

26. The method of claim 25, wherein the hydrogen sensor material includes a thin film metal oxide.

27. The method of claim 22, wherein the conformable substrate film includes a sheet of cling wrap plastic film.

28. The method of claim 27, wherein the cling wrap plastic film comprises a polymer material that is in a range of 0.11 to 0.15 mm thick.

29. The method of claim 27, wherein the cling wrap plastic film comprises a polymer selected from a group comprising polyvinyl chloride (PVC), polyvinylidene chloride (PVCdC), and low density polyethylene (LDPE).

30. The method of claim 22, wherein the conformable material includes a shrink wrap plastic material.
